(19) United States
(12) Patent Application Publication
(10) Pub. No.: US 2023/0274631 A1
(43) Pub. Date: Aug. 31, 2023

(54) MEASURING DEVICE

(71) Applicant: VEGA Grieshaber KG, Wolfach (DE)

(72) Inventors: Roland WELLE, Hausach (DE); Karl GRIESSBAUM, Muehlenbach (DE)

(73) Assignee: VEGA Grieshaber KG, Wolfach (DE)

(21) Appl. No.: 18/040,396

(22) PCT Filed: Aug. 6, 2020
(86) PCT No.: PCT/EP2020/072113

§ 371 Date: Feb. 2, 2023

(51) Int. Cl. G08C 19/02; G01D 21/02

(52) U.S. Cl. CPC G08C 19/02; G01D 21/02

(57) ABSTRACT

A measuring device for detecting a measured value is provided, including: at least one two-wire interface configured for communication of the measuring device with an evaluation device; at least one first communication device configured to provide communication with the evaluation device in a first communication mode via the at least one two-wire interface; at least one second communication device configured to provide communication with the evaluation device in a second communication mode via the at least one two-wire interface; at least one selection device configured to activate the first communication device or the second communication device such that the measuring device communicates with the evaluation device via the at least one two-wire interface in the first communication mode or in the second communication mode. A method for selecting a communication mode of a measuring device, and a system for acquiring a measured value, are also provided.

### FIELD OF INVENTION

The present invention relates to a measuring device for acquiring a measured value, a method for selecting a communication mode of the measuring device, a system for acquiring the measured value, and a use of a first, second and/or third communication unit in the measuring device and/or a use of an evaluation device in the system.

### BACKGROUND

Measuring devices are generally known in the state of the art and are used, for example, in the process and chemical industry for monitoring process parameters such as fill levels, limit levels, pressures, densities, etc. The measurement data generated during the measurement are transmitted, for example, via corresponding interfaces to a connected evaluation device.

In this context, it has now become apparent that there is a further need to provide a measuring device for the acquisition of a measured value for such a transmission, in particular there is a need to provide an efficient, cost-effective and sustainable measuring device for the acquisition of measured values.

These and other objects which will still be mentioned when reading the following description or which can be recognized by the person skilled in the art are solved by the subject matter of the independent claims. The dependent claims further form the central idea of the present invention in a particularly advantageous manner.

### SUMMARY OF THE INVENTION

According to a first aspect of the present invention, there is provided a measuring device for detecting a measured value, comprising: at least one two-wire interface arranged for communication of the measuring device with an evaluation device; at least one first communication unit arranged to provide communication with the evaluation device in a first communication mode via the at least one two-wire interface; at least one second communication unit set up to provide communication with the evaluation device in a second communication mode via the at least one two-wire interface; at least one selection unit set up to activate the first communication unit or the second communication unit such that the measuring device communicates with the evaluation device via the two-wire interface in the first communication mode or in the second communication mode.

For data exchange, measuring devices and evaluation devices must provide/enable the same communication technology/standards. In existing plants in process technology, however, evaluation devices with different communication modes are often in use, since the plants are often successively modernized or equipped with new evaluation devices and/or measuring instruments. If, for example, measuring devices with different communication modes are used, corresponding evaluation devices with different communication modes must also be used in order to provide communication between these devices. However, this necessity increases the cost and also lowers the flexible use of the various devices in a plant. The present invention avoids or at least reduces these disadvantages.

The term measured value is to be understood broadly in the present context and includes all physical measurands, such as density, weight, temperature, distances, fill levels. The term measuring device is also to be understood broadly in the present context and includes all devices/devices/devices that are suitable for recording a physical measurand, such as temperature sensors, radar sensors, capacitive sensors, pressure sensors, etc. A two-wire interface is based on a two-wire line and is suitable for transmitting a measured value and/or further data between the measuring device and an evaluation device. In addition, a two-wire interface can thereby also serve to supply power to the measuring device. The term communication is to be understood broadly in the present context and includes any analog/digital data exchange between a measuring device and an evaluation device. Communication can take place directly between the measuring device and the evaluation device or indirectly if, for example, other measuring devices are arranged in the communication path and communication is forwarded via them. In particular, measurement data, status data of the measuring device and/or control commands can be transmitted. The term evaluation devices is also to be understood broadly in the present context and includes all controllers and/or data processing devices that are suitable for analyzing or processing data, e.g. PLCs, industrial PCs, PCs, smartphones, tablets, microcontrollers. The term selection unit is also to be understood broadly in the present context and includes, for example, hardware and software components that may be integrated in one assembly and/or distributed over several assemblies. For example, the selection unit may comprise a PLC or an integrated circuit (IC) or a microcomputer chip. The term communication unit in the present context includes equipment that provides hardware and software for a communication mode. In this context, the hardware may also be implemented via relay circuits, for example. In the following, the term communication mode refers to communication technologies/protocols/standards, such as communications via a 4 . . . 20 mA current interface, by means of Highway Addressable Remote Transducer, or by means of Ethernet Advanced Physical Layer, etc.

In a particularly preferred embodiment, the measuring device thereby comprises a two-wire interface and adapts the communication mode depending on the communication mode present/preset in the evaluation device. As a result, an existing two-wire line present in the system for connecting the evaluation device to the measuring device can be used. This leads to cost advantages if, for example, a new measuring device according to the invention is to be implemented in an existing plant, since such a device is suitable, for example, for older (e.g. 4 . . . 20 mA) as well as for newer communication modes (e.g. Ethernet APL), thereby also significantly reducing the implementation effort.

In an embodiment, the measuring device comprises a first communication unit and a second communication unit, wherein these use different modulation methods for implementing a data transmission. In particular, it may be provided to provide a first communication unit using a digital modulation method with a second communication unit using an analog modulation method. For example, it can be provided that the first communication unit implements a digital communication according to the Ethernet Advanced Physical Layer (Ethernet APL) standard, and the second communication unit implements an analog communication according to 4 . . . 20 mA. In one embodiment, the second communication unit may be designed to implement mixed analog and digital communication according to the analog 4 . . . 20 mA standard with simultaneous digitally modulated signal according to the Highway Addressable Remote Transducer standard.

In an embodiment, the measuring device comprises a first communication unit and a second communication unit, wherein these use different digital or exclusively digital modulation methods to implement data transmission. For example, the first communication unit may implement digital communication according to the Ethernet Advanced Physical Layer (Ethernet APL) standard, and the second communication unit may implement purely digital communication according to the Highway Addressable Remote Transducer standard.

Preferably, the measuring device comprises at least one third communication unit, which is set up to provide communication with the evaluation device in a third communication mode via the at least one two-wire interface, wherein the selection unit is set up to activate one of the communication units such that the measuring device communicates with the evaluation device via the at least one first two-wire interface in one of the communication modes. By means of the third communication unit, a third communication mode can be implemented via the same two-wire interface, which increases the flexibility of the measuring device with respect to the connection to evaluation devices having different communication modes.

Preferably, the first communication mode is an Ethernet Advanced Physical Layer (Ethernet APL) communication, the second and/or the third communication mode is preferably a Highway Addressable Remote Transducer (HART) communication or a 4 . . . 20 mA current interface communication. The 4 . . . 20 mA communication mode is an analog communication mode, whereas the HART communication mode is a digital communication mode. These two communication modes are currently widely used in existing plants, although it should also be possible to use the more modern Ethernet APL communication mode in plants. By providing these three communication modes in particular, a metering device can be used in both older existing plants and new plants. However, the communication modes provided by the measurement device are not limited to the examples given, any other communication modes compatible with a two-wire technology can be selected. These still include, for example, 10BASET-1L and 10BASET-1S. Furthermore, Profibus PA, Foundation Fieldbus, Profinet, HART-IP, Modbus, Modbus-TCP or UPC-UA also count as two-wire technologies in the context of the present invention.

Preferably, the communication units each comprise at least one circuit unit that is set up in each case to provide the operating parameters provided for the respective communication mode on the two-wire interface (for example, to provide the current strength, voltage or modulation form required for this). The communication units physically set and/or read out the operating parameters on the two-wire interface via circuits.

Preferably, the communication units each comprise at least one software unit, each of which is set up to provide a communication protocol intended for the respective communication mode. The communication protocols can be, for example, 4 . . . 20 mA, HART and/or APL. The respective communication protocols may thereby be stored in a volatile or non-volatile memory, for example. It is also possible that the various communication protocols are provided on a chipset as so-called embedded software.

Preferably, the selection unit activates the first communication unit or the second communication unit and/or the third communication unit based on a response signal of the evaluation device to a communication signal of the selection unit. By such activation of the respective communication unit, the respective communication mode may be automatically set or provided. In other words, the communication mode of the evaluation unit can be interrogated and then the respective communication unit can be turned on or off accordingly. For example, the selection unit can (preferably) transmit a first communication signal in the first communication mode, a second communication signal in the second communication mode, and/or a third communication signal in the third communication mode to the evaluation unit, and based on a response signal from the evaluation unit, the first, second, and/or third communication mode can be enabled/disabled. As a result, the determination or setting of the suitable communication mode can be performed quasi-automatically. By automating the determination or setting of the communication mode, the implementation effort can be reduced considerably.

Preferably, the measuring device comprises at least one power supply unit that is set up to convert an incoming voltage and to supply the measuring device and/or an energy storage device with energy. This makes it possible to supply the measuring device with the energy necessary for operation. This further makes it possible, if necessary, to preset the current at the two-wire interface. In this context, it is preferred that the at least one power supply unit is operable in different operating modes and the respective operating mode of the at least one power supply unit is selectable based on the activated communication mode. The various operating modes can differ in terms of the amount of electrical power that can be extracted and provided by sensors. For example, in a first operating mode in a pure 4 . . . 20 mA mode, only the current corresponding to the measured value to be output can be drawn by the power supply unit from the supply and evaluation device. In an example, this can be a current of 4 mA at a typical voltage of 16V, resulting in a total power of 64 mW. On the other hand, if a second operating mode is activated for an APL operation, several hundred milliwatts of electrical power can be drawn from the supply and evaluation device and made available for sensor operation. This allows measurement equipment to be operated more efficiently. However, the power supply unit can also include multiple sub-units optimized for different communication modes in terms of efficiency. This can improve energy efficiency in an advantageous manner.

In another aspect, the present invention relates to a method for selecting a communication mode of a measuring device, comprising at least the following steps: Sending a first communication signal via a two-wire interface through a selection unit to an evaluation device, wherein the first communication signal is based on a first communication mode; activating a first communication unit if a response signal of the evaluation device corresponds to the first communication mode; and/or sending a second communication signal via the two-wire interface through the selection unit to the evaluation device, wherein the second communication signal is based on a second communication mode; activating the second communication unit when a response signal of the evaluation device corresponds to the second communication mode; and/or sending a third communication signal via the two-wire interface by the selection unit to an evaluation device, the third communication signal being based on a third communication mode; activating the third communication unit when a response signal of the evaluation device corresponds to the third communication mode. Preferably, the method further comprises storing energy from a two-wire interface in an energy storage device by at least one power supply unit. Furthermore, it is preferred that the method further comprises selecting an operating mode of the at least one power supply unit based on the activated communication mode. Preferably, the method thereby runs in an automated manner, which reduces the implementation effort and reduces the error probabilities due to human intervention.

In another aspect, the present invention relates to a system for acquiring a measured value, comprising: at least one measuring device; at least one evaluation unit arranged to communicate with the at least one measuring device in a first communication mode and/or in a second communication mode and/or in a third communication mode.

Finally, another aspect of the present invention relates to the use of a first, second and/or third communication unit in a measuring device; and/or the use of an evaluation device in a system for acquiring a measured value.

### DESCRIPTION OF THE PREFERRED EMBODIMENTS

Below is a detailed description of the figures, therein shows

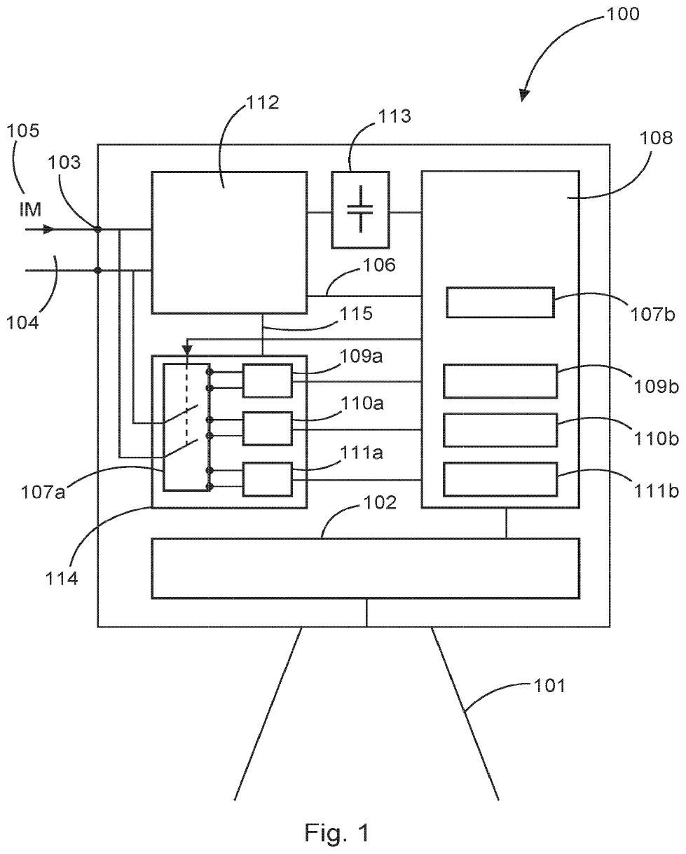

FIG. 1 a schematic partial view of a preferred embodiment of a measuring device according to the invention for recording a measured value; and

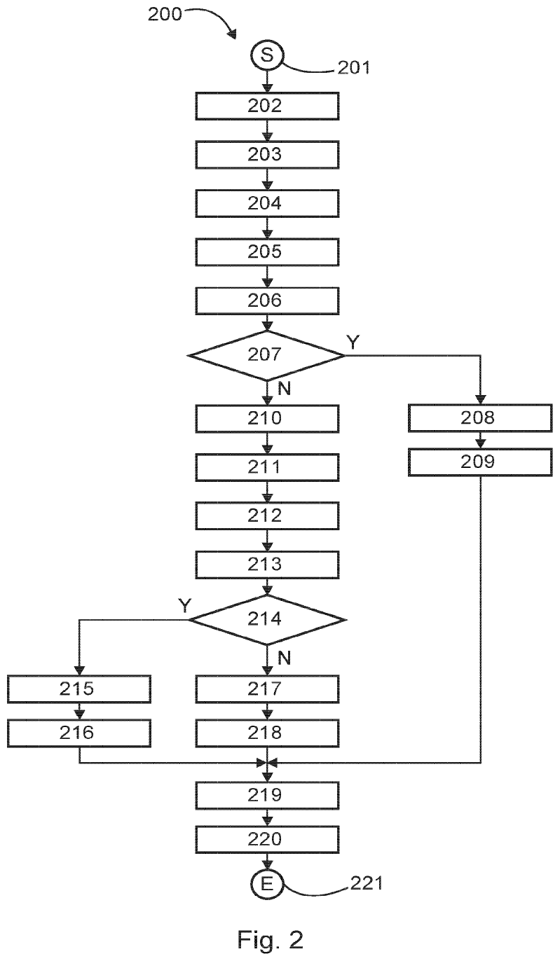

FIG. 2 a schematic representation of a method according to the invention for selecting a communication mode of a measuring device according to the invention.

FIG. 1 shows a schematic partial view of a preferred embodiment of a measuring device 100 according to the invention for acquiring a measured value. The measuring device 100 comprises a sensor 101 and a measured value determination unit 102 for acquiring the measured values. The measuring device 100 further comprises a two-wire interface 103, which is connected to an evaluation device or a supply and evaluation device (not shown) via a two-wire line 104. The two-wire line 104 can thereby be used to transmit both data and power between the measurement device 100 and the evaluation device. The energy can further be converted via a power supply unit 112 and stored in an energy storage 113. The measurement device 100 further comprises a selection unit 107, comprising a hardware selection unit 107a and a software selection unit 107b, which are interconnected. The software selection unit 107b is preferably integrated in a microcontroller 108 of the measuring device 100. In the shown embodiment, the measuring device 100 further comprises three communication units 109, 110, 111, wherein the communication unit 109 comprises a circuit unit 109a and a software unit 109b; the communication unit 110 comprises a circuit unit 110a and a software unit 110b, and the communication unit 111 comprises a circuit unit 111a and a software unit 111b. In this regard, the circuit units 109a, 110a,111a and the hardware selection unit 107a may be combined into a circuit assembly 114.

In this context, the communication units 109, 110 and 111 are each set up to provide a communication mode (e.g. HART, 4 . . . 20 mA and/or Ethernet APL). In doing so, the circuit units 109a, 110a, 111a set or read appropriate voltages, currents, and/or modulation forms on the two-wire interface 103 to thus physically implement communication over the two-wire line 104. The software units 109b, 110b, 111b implement the protocol level of the respective communication mode. The measurement device 100 can obtain the power necessary for operation from the two-wire line 104 and thus via the two-wire interface 103. The power is drawn from the two-wire line 104 by the power supply unit 112, and is made available to the other hardware units of the measurement device 100 using, for example, an energy storage device 113. In the shown embodiment, the microcontroller 108 is connected to the measured value determination unit 102, which is arranged to determine at least one measured value using the sensor 101, for example (ultrasonic sensor, radar sensor, pressure sensor, vibration sensor, conductive or capacitive sensor, etc.) to determine at least one measured value and transmit it to the microcontroller 108.

In response to a signal from the software selection unit 107b, the hardware selection unit 107a is arranged to physically connect one of the circuit units 109a, 110a, 111a to the two-wire interface 103 and thus to the two-wire line 104.

Furthermore, provision may be made to additionally connect the circuit assembly 114 to the power supply unit 112 via a control line 115. This may provide for instructing the power supply unit 112 to set a presettable current IM 105 on the two-wire line 104. However, it may alternatively or additionally be provided that this is implemented directly by the microcontroller 108 via a line 106.

In the embodiment shown, the task of extracting power from the line 104 is generically provided using a common power supply unit 112. However, it may alternatively be contemplated to provide a plurality of power supply units 112 comprising circuit components optimized for different communication modes to increase efficiency. It may also be provided for modifying the power supply unit 112 such that it can be set to a plurality of different operating modes via a predeterminable control signal, which activate and/or deactivate circuit components optimized for one or more communication modes.

In particular, the technical function of the hardware selection unit 107a is to connect the appropriate circuit units 109a, 110a, 111a necessary to implement a particular communication mode to the two-wire interface 103. This may be accomplished, for example, by mechanical relays, solid state relays, or other switches. However, resistive-acting, capacitive-acting, or otherwise implemented electronic circuits may also be used to effect coupling or decoupling of communication signals on the two-wire line 104. In addition, logic circuits may also be used at this point.

The software units 109b, 110b, 111b for protocol-side implementation of various communication modes may be present in a memory of the microcontroller 108. It may also be provided that they are stored in a memory external to the microcontroller 108, for example a non-volatile memory. It may further be provided that these software units 109b, 110b, 111b are all loaded into the main memory of the microcontroller 108 during start-up. Alternatively, it may be provided that the software units 109b, 110b, 111b are loaded only when necessary.

Further, it may be provided that some or all of the assemblies including the power supply unit 112, the circuit assembly 114 and/or the microcontroller 108 including the software units 109b, 110b, 111b are provided in a single integrated device. Furthermore, it may be provided that the microcontroller 108 is part of the measurement determination unit 102.

FIG. 2 shows a schematic representation of a method according to the invention for selecting a communication mode of a measuring device of the first embodiment. The method starts in the start state 201, for example when the measuring device 100 is switched on. In step 202, energy is extracted from the two-wire interface 103 by the power supply unit 112, and collected in the energy storage 113. For this purpose, for example, the measuring device 100 sets a current on the two-wire line 103 that corresponds to a fault signal for a 4 . . . 20 mA communication mode, for example a current of 3.55 mA. If sufficient power is available, in step 203 the microcontroller 108 is activated, and its program code is loaded and executed. In step 204, the circuit unit 110a (HART) is activated, and connected to the two-wire interface 103 by driving it using the hardware selection unit 107a. In step 205, the software selection unit 107b loads and executes the software unit 110b (HART), whereupon in step 206 (possibly after being requested by an evaluation device) a communication signal is sent in accordance with the HART communication mode via the two-wire line 104 in the direction of an evaluation device. In step 207, it is checked whether a response to the HART communication signal can be received at the two-wire interface 103.

If this is the case, further HART initialization sequences can be processed in step 208, and commands can be sent to the power supply unit 112 in (optional) step 209 to set an optimum operating state for HART. With reference to the current on the two-wire line 104, this is, for example, a current proportional to the measured value in the range from 4 to 20 mA or, in the case of HART multidrop operation, a constant current. In step 219, at least one measured value is determined with the aid of the measured value determination unit 102, whereupon this is provided externally in the direction of an evaluation device in step 220 via the previously activated communication unit 110 (HART). The method ends in state 221.

If no HART response is received in step 207, circuit unit 110a (HART) is deactivated in step 210 before circuit unit 111a (Ethernet APL) is activated in step 211 and connected to interface 103 by driving using hardware selection unit 107a. In step 212, software unit 111b is loaded and executed by software selection unit 107b, whereupon, in step 213, a communication signal is sent in accordance with Ethernet APL communication mode over two-wire line 104 toward an evaluation device. In step 214, it is checked whether a response to the Ethernet APL communication signal can be received at the interface 103.

If this is the case, further Ethernet APL initialization sequences can be processed in step 215, and commands can be sent to the power supply unit 112 in (optional) step 216 in order to set an optimum operating state for Ethernet APL, for example by drawing larger amounts of power via the setting of a constant current on the two-wire line 104, for example a current of 25 mA. In step 219, at least one measured value is determined by means of the measured value determination unit 101, whereupon, in step 220, the measured value is transmitted to the outside in the direction of an evaluation device via the previously activated communication unit 111 (Ethernet APL). The method ends in state 221.

If no APL response is received in step 514, the circuit unit 111a (APL) is deactivated in step 217 before the circuit unit 109a (4 . . . 20 mA) is activated in step 218 and connected to the interface 103 by control using the hardware selection unit 107a. Moreover, the connection 115 may be used to enable the circuit unit 109a to control the power supply unit 112. Henceforth, the measuring device 100 can determine measured values in steps 219 and 220 and transmit them toward an evaluation device via a current value IM 417 set on the two-wire line 104.

The aforementioned procedure can be executed automatically at each start-up or start-up of the measuring device 100 after a voltage has been supplied to the two-wire line 104. In this way, it can be achieved that, in particular in existing systems, the measuring device 100 communicates with an evaluation device at a first time according to the 4 . . . 20 mA communication mode. If the system is modernized at a later time, for example by replacing the evaluation device with a newer evaluation device, a measuring device according to the invention will automatically activate and use the new communication mode after being switched on again. In this way, it becomes possible to provide measuring devices that enable the successive modernization of existing plants.

The present embodiment combines the analog 4 . . . 20 mA communication mode with the digital communication modes according to the HART communication mode and the Ethernet APL communication mode. However, the invention is not limited to the above communication modes. By way of example, it may also be implemented with Profibus PA, Foundation Fieldbus, Profinet, HART-IP, Modbus, Modbus-TCP, or UPC-UA.

In another embodiment, an operator may select a communication mode via an operator input. In a further embodiment, the selection of the communication mode may be automated based on an event, such as a voltage and or current change.

However, the present invention is not limited in this regard to the foregoing preferred embodiments so long as it is encompassed by the subject matter of the following claims.

In addition, it is pointed out that the terms “comprising” and “comprising” do not exclude other elements or steps, and the indefinite articles “one” or “a” do not exclude a plurality. Furthermore, the term unit is to be understood broadly, and in particular this term is not to be understood to mean that the respective units must be integral components. Also, the respective units may also be positioned differently. Finally, different units may also be combined in one assembly. Furthermore, it is pointed out that features or steps that have been described with reference to one of the above embodiments may also be used in combination with other features or steps of other embodiments described above.

### LIST OF REFERENCE SIGNS

100 Measuring device
101 Sensor
102 Measurement determination unit
103 Two-wire interface (103)
104 Two-wire line
105 Current IM
106 Management
107 Selection unit
107a Hardware selection unit
107b Software selection unit
108 Microcontroller
109, 110, 111 Communication unit
109a, 110a, 111a Circuit unit
109b, 110b, 111b Software unit
112 Power supply unit
113 Energy storage
114 Circuit board
115 Control line

1.-15. (canceled)

16. A measuring device for detecting a measured value, comprising:
at least one two-wire interface configured for communication of the measuring device with an evaluation device;
at least one first communication unit configured to provide communication with the evaluation device in a first communication mode via the at least one two-wire interface;
at least one second communication unit configured to provide communication with the evaluation device in a second communication mode via the at least one two-wire interface;
at least one selection unit configured to activate the first communication unit or the second communication unit such that the measuring device communicates with the evaluation device via the at least one two-wire interface in the first communication mode or in the second communication mode.

17. The measuring device according to claim 16,
further comprising at least one third communication unit configured to provide communication with the evaluation device in a third communication mode via the at least one two-wire interface,
wherein the at least one selection unit is further configured to activate one of the communication units such that the measuring device communicates with the evaluation device in one of the communication modes via the at least one two-wire interface.

18. The measuring device according to claim 16, wherein the first communication mode is Ethernet Advanced Physical Layer (Ethernet APL) communication and the second and/or the third communication mode is/are Highway Addressable Remote Transducer (HART) communication or 4 . . . 20 mA current interface communication.

19. The measuring device according to claim 18, wherein the at least one selection unit is further configured such that the 4 . . . 20 mA current interface communication and HART communication are simultaneously connected to the at least one two-wire interface and the HART communication is modulated onto the 4 . . . 20 mA communication.

20. The measuring device according to claim 17, wherein the communication units each comprise at least one circuit unit, each of which is configured to provide operating parameters provided for the respective communication mode at the at least one two-wire interface.

21. The measuring device according to claim 20, wherein the operating parameters are current, voltage, and modulation form.

22. The measuring device according to claim 17, wherein the communication units each comprise at least one software unit each configured to provide a communication protocol for the respective communication mode.

23. The measuring device according to claim 17, wherein the at least one selection unit is further configured to activate the first communication unit or the second communication unit and/or the third communication unit based on a response signal of the evaluation device to a communication signal of the at least one selection unit.

24. The measuring device according to claim 23, wherein the at least one selection unit is further configured to send as a communication signal at least a first communication signal in the first communication mode to the evaluation device, and/or to send a second communication signal in the second communication mode to the evaluation device, and/or to send a third communication signal in the third communication mode to the evaluation device, and to activate/deactivate the first, the second, and/or the third communication mode based on a response signal of the evaluation device.

25. The measuring device according to claim 16, further comprising at least one power supply unit configured to convert an incoming voltage and to supply power to the measuring device and/or to an energy storage device.

26. The measuring device according to claim 25,
wherein the at least one power supply unit is operable in different operating modes, and
wherein a respective operating mode of the at least one power supply unit is selected based on an activated communication mode.

27. A method for selecting a communication mode of a measuring device according to claim 16, the method comprising the following steps:
sending a first communication signal via a two-wire interface through a selection unit to an evaluation device, wherein the first communication signal is based on a first communication mode;
activating a first communication unit when a response signal of the evaluation device corresponds to the first communication mode; and/or
sending a second communication signal via the two-wire interface by the selection unit to the evaluation device, wherein the second communication signal is based on a second communication mode;
activating the second communication unit when a response signal of the evaluation device corresponds to the second communication mode; and/or
sending a third communication signal via the two-wire interface by the selection unit to an evaluation device, wherein the third communication signal is based on a third communication mode; and
activating the third communication unit when a response signal from the evaluation device corresponds to the third communication mode.

28. The method according to claim 27, further comprising:
storing energy from a two-wire interface in an energy storage device by at least one power supply unit.

29. The method according to claim 27, further comprising:
selecting an operating mode of the at least one power supply unit based on an activated communication mode.

30. A system for acquiring a measured value, comprising:
at least one measuring device according to claim 16;
at least one evaluation unit arranged to communicate with the at least one measuring device in a first communication mode and/or in a second communication mode and/or in a third communication mode.
